(19) United States
(12) Patent Application Publication
(10) Pub. No.: US 2007/0222422 A1
(43) Pub. Date: Sep. 27, 2007

(54) POWER SUPPLY DEVICE AND ELECTRICAL DEVICE EQUIPPED WITH THE SAME

(75) Inventors: Hiroki INOUE, Kyoto (JP); Kenya KONDO, Fukuoka (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Kyoto (JP)

(21) Appl. No.: 11/688,313

(22) Filed: Mar. 20, 2007

(30) Foreign Application Priority Data
Mar. 23, 2006 (JP) 2006-079972

(51) Int. Cl. G05F 1/00

(52) U.S. Cl. 323/274

(57) ABSTRACT

A power supply device includes a first transistor connected in series between an input terminal to which an input voltage is applied and an output terminal from which an output voltage is led out; a second transistor connected between the input terminal and the output terminal in parallel with the first transistor, and which is arranged to supply a portion of the output current to a load as a detection current; a control voltage production unit arranged to produce a control voltage of the first and second transistors so that the output voltage is maintained at a specified target value; a first constant current source arranged to produce a first constant current; a variable current source arranged to produce a variable current in accordance with the output voltage; a first resistor arranged to produce a reference voltage in accordance with a combined current of the first constant current and the variable current; a second constant current source arranged to produce a second constant current; a second resistor arranged to produce a detection voltage in accordance with a combined current of the second constant current and the detection current; and an offset circuit arranged to apply an offset to the control voltage in accordance with the reference voltage and the detection voltage.

### BACKGROUND OF THE INVENTION

1. Field of the Invention

The present invention relates to a power supply device which monitors output current and performs overcurrent protection, and also relates to an electrical device equipped with such a power supply device.

2. Description of the Background Art

Various types of direct-current stabilized power supply devices which monitor output current and perform overcurrent protection have been disclosed or proposed in the past. See, for example, Japanese Unexamined Patent Application No. H10-14099 (Patent Reference 1), Japanese Unexamined Patent Application No. S57-152021 (Patent Reference 2), and Japanese Unexamined Patent Application No. H8-115135 (Patent Reference 3).

Furthermore, many of the conventional direct-current stabilized power supply devices use a circuit construction that provides overcurrent protection such that the correlation characteristics between the output current io and the output voltage Vo exhibit so-called “constant-current drooping characteristics” (for example, see FIG. 1A in Patent Reference 2 or FIG. 2(B) in Patent Reference 3) or “modified fold-back drooping characteristics” (for example, see FIGS. 3 and 5 in Patent Reference 2 or FIG. 1(B) in Patent Reference 3).

To describe this in specific terms, the overcurrent protective behavior indicating conventional “constant-current drooping characteristics” is as follows: namely, as is shown in FIG. 6(a), this behavior includes a first protective period a (horizontal period) in which the output voltage Vo is maintained at a target value Vreg without any limitation of the output current io, and a second protective period b (vertical period) in which the output current io is clamped to a specified upper limit value ilmt, and the output voltage Vo is reduced in a drooping configuration. Furthermore, as is shown in FIG. 6(b), the overcurrent protective behavior indicating conventional “modified fold-back drooping characteristics” is as follows: namely, this behavior includes a third protective period c (fold-back period) in which the output current io and output voltage Vo are both reduced in a recursive configuration after the output voltage Vo is reduced in a drooping configuration to a specified upper limit value Vlmt via the above-mentioned second protective period b.

To be sure, overcurrent of the output current can be prevented using the conventional direct-current stabilized power supply devices mentioned above. Accordingly, the stability and reliability of devices against output short-circuiting and the like can be increased.

However, in the direct-current stabilized power supply devices mentioned above, after the output current io reaches the upper limit value ilmt, an excessive output current io (upper limit value ilmt) continues to flow during the period in which the output voltage Vo is reduced in a drooping configuration (i.e., the second protective period b). Accordingly, a large power loss occurs, and in the worst case, the element may be damaged during this period.

In addition, various types of overcurrent protective circuits exhibiting “fold-back drooping characteristics” that do not include the above-mentioned second protective period b have also been disclosed or proposed in the past (for example, see FIG. 1B in Patent Reference 2 or FIG. 3(B) in Patent Reference 3. Furthermore, it is indicated in Patent Reference 2 that such characteristics suffer from drawbacks).

However, in the conventional circuit described in Patent Reference 2, a Zener diode is used. Accordingly, this circuit cannot be set at an arbitrary voltage, and it is therefore difficult to realize desired overcurrent protection characteristics. Moreover, in the conventional circuit described in Patent Reference 3, an unnecessary resistor component is required during input and output.

### SUMMARY OF THE INVENTION

In order to overcome the problems described above, preferred embodiments of the present invention provide a power supply device which makes it possible to realize a stable overcurrent protective action while suppressing any unnecessary power loss, and an electrical device including such a novel power supply device.

A preferred embodiment of the present invention provides a power supply device including a first transistor which is connected in series between an input terminal to which an input voltage is applied and an output terminal from which an output voltage is led out; a second transistor which is connected between the input terminal and the output terminal in parallel with the first transistor, and which is used to supply a portion of the output current to the load as a detection current; a control voltage producing unit that is arranged to produce a control voltage of the first and second transistors so that the output voltage is maintained at a specified target value; a first constant current source which produces a first constant current; a variable current source which produces a variable current in accordance with the output voltage; a first resistor which produces a reference voltage in accordance with the combined current of the first constant current and the variable current; a second constant current source which produces a second constant current; a second resistor which produces a detection voltage in accordance with the combined current of the second constant current and the detection current; and an offset circuit which applies an offset to the control voltage in accordance with the reference voltage and the detection voltage.

According to another preferred embodiment of the present invention, in a power supply device having the construction described above, the power supply device may preferably have a construction in which the variable current source reduces the variable current in accordance with the drop in the output voltage, the reference voltage and the detection voltage exhibit a rise in the voltage value in accordance with the decrease in the currents respectively flowing through the first and second resistors, and the offset circuit does not apply any offset to the control voltage when the detection voltage is higher than the reference voltage, and conversely applies an offset to the control voltage so that the first and second transistors are closed in accordance with the increase in the differential voltage when the detection voltage is lower than the reference voltage.

Furthermore, in another preferred embodiment of the present invention, an alternative construction may be used in which the variable current source includes a constant current source which produces a specified constant current; a PNP bipolar transistor whose emitter is connected to the output terminal of the constant current source, whose collector is connected to the ground terminal, and whose base is connected to the application terminal of the output voltage or divided voltage thereof; and an NPN bipolar transistor whose base is connected to the emitter of the PNP bipolar transistor, whose emitter is connected to the ground terminal via a resistor, and whose collector is connected to the output terminal of the variable current.

Furthermore, in any of the above-described preferred embodiments, the first and second transistors may be field effect transistors.

Furthermore, another preferred embodiment of the present invention includes an electrical device power supply, and a power supply device constituting an output converter for the device power supply, with the electrical device being equipped with the power supply device according to any of the preferred embodiments of the present invention described above.

Various preferred embodiments of the present invention make it possible to provide a power supply device which can realize a stable overcurrent protective action while suppressing any unnecessary power loss, and an electrical device equipped such a power supply device.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram showing a preferred embodiment of the electrical device of the present invention.

FIG. 2 is a circuit diagram showing one example of the construction of the power supply device 20.

FIG. 3 is a circuit diagram showing one example of the construction of the offset circuit OFS.

FIG. 4 is a circuit diagram showing one example of the construction of the variable current source Iv.

FIG. 5 is a correlation graph of io-Vo in a preferred embodiment of the present invention.

FIGS. 6(a) and 6(b) show conventional io-Vo correlation graphs.

### DETAILED DESCRIPTION OF PREFERRED EMBODIMENTS

Below, a description will be given using as an example a case in which preferred embodiments of the present invention are applied to a power supply device which is mounted on an electrical device (vehicle IC or the like) using a battery as a device power supply, and which converts the output voltage of the battery to produce a load driving voltage.

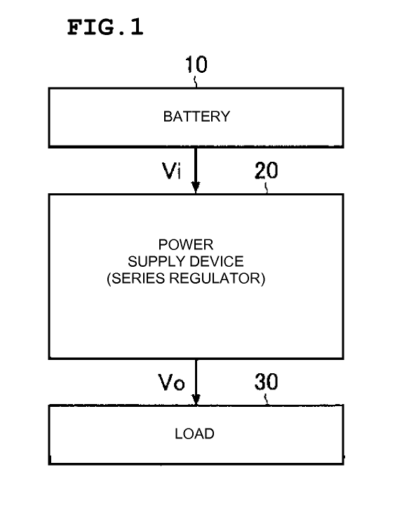

FIG. 1 is a block diagram showing a preferred embodiment of the electrical device of the present invention (in particular, a part of the power supply system to the load). As is shown in this figure, the electrical device of the present preferred embodiment preferably includes a battery 10 constituting a device power supply, a power supply device 20 constituting an output converter for the battery 10, and a load 30 which is driven by the output voltage Vo from the power supply device 20.

The power supply device 20 produces a constant output voltage Vo from the input voltage Vi that is supplied from the battery 10, and supplies this output voltage Vo to the load 30.

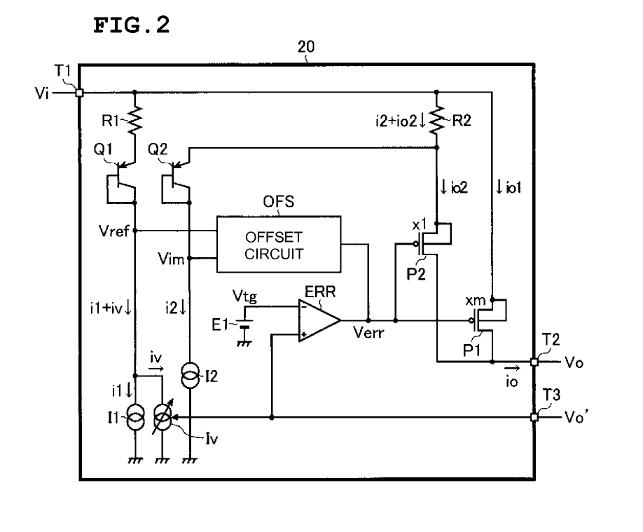

FIG. 2 is a circuit diagram (including a partial block diagram) showing one example of the construction of the power supply device 20.

As is shown in this figure, the power supply device 20 of the present preferred embodiment preferably includes a P-channel field effect transistor P1, a P-channel field effect transistor P2, an error amplifier ERR, a direct-current voltage source E1, constant-current sources 11 and 12, a variable current source Iv, resistors R1 and R2, PNP bipolar transistors Q1 and Q2, and an offset circuit OFS.

The source of the transistor P1 is connected to the input terminal T1 into which the input voltage Vi (battery voltage) is input. The drain of the transistor P1 is connected to the output terminal P2 from which the output voltage Vo is led out. The gate of the transistor P1 is connected to the output terminal of the error amplifier ERR. The back gate of the transistor P1 is connected to the source of the transistor P1.

In other words, the transistor P1 is an output transistor which is connected in series between the input terminal T1 and output terminal T2.

The source of the transistor P2 is connected to the input terminal T1 via a resistor R2. The drain of the transistor P2 is connected to the output terminal T2. The gate of the transistor P2 is connected to the output terminal of the error amplifier ERR. The back gate of the transistor P2 is connected to the source of the transistor P2. In other words, the transistor P2 is a current detection transistor which is connected between the input terminal T1 and output terminal T2 in parallel with the transistor P1, and which is used to supply a portion of the output current io to the load (not shown) as a detection current io2.

The non-inverting input terminal (+) of the error amplifier ERR is connected to the feedback terminal T3 to which the feedback voltage Vo′ (generally a divided voltage of the output voltage Vo) whose voltage value fluctuates in accordance with the output voltage Vo is applied. The inverting input terminal (−) of the error amplifier ERR is connected to the positive terminal of the direct-current voltage source E1. Furthermore, the negative terminal of the direct-current voltage source E1 is grounded. The output terminal of the error voltage amplifier ERR is connected respectively to the gates of the transistors P1 and P2, and is also connected to the output terminal of the offset circuit OFS.

One end of the resistor R1 is connected to the input terminal T1. The other end of the resistor R1 is connected to the emitter of the transistor Q1. The collector of the transistor Q1 is grounded via the constant current source I1 and variable current source Iv, and is also connected to the reference voltage input terminal of the offset circuit OFS. The base of the transistor Q1 is connected to the collector of the transistor Q1.

One end of the resistor R2 is connected to the input terminal T1. The other end of the resistor R2 is connected to the source of the transistor P2, and is also connected to the emitter of the transistor Q2. The collector of the transistor Q2 is grounded via the constant current source 12, and is also connected to the detection voltage input terminal of the offset circuit OFS. The base of the transistor Q2 is connected to the collector of the transistor Q2.

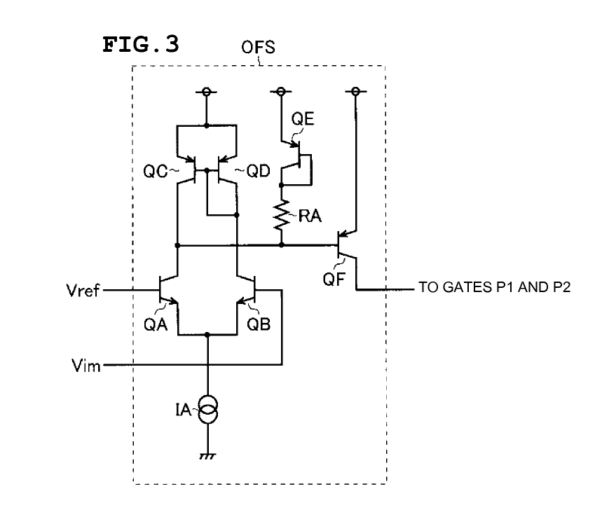

FIG. 3 is a circuit diagram showing one example of the construction of the offset circuit OFS.

As is shown in this figure, the offset circuit OFS of the present preferred embodiment preferably includes NPN bipolar transistors QA and QB, PNP bipolar transistors QC through QF, a resistor RA, and a constant current source IA.

The base of the transistor QA corresponds to the reference voltage input terminal of the offset circuit OFS. The collector of the transistor QA is connected to the collector of the transistor QC, and is also connected to the base of the transistor QF. The base of the transistor QB corresponds to the detection voltage input terminal of the offset circuit OFS. The collector of the transistor QB is connected to the collector of the transistor QD.

The emitters of the transistors QA and QB are connected to each other, and the connection node is grounded via the constant current source IA. The emitters of the transistors QC and QD are connected to each other, and the connection node is connected to the power supply application terminal (input terminal T1). The bases of the transistors QC and QD are connected to each other, and the connection node is connected to the collector of the transistor QD.

The emitter of the transistor QE is connected to the power supply application terminal. The collector of the transistor QE is connected to the base of the transistor QF via the resistor RA. The base of the transistor QE is connected to the collector of the transistor QE. The emitter of the transistor QF is connected to the power supply application terminal. The collector of the transistor QF corresponds to the output terminal of the offset circuit OFS.

Specifically, the offset circuit OFS constructed as described above applies an offset to the error voltage Verr in accordance with the reference voltage Vref and detection voltage Vim. Furthermore, the operation of the offset circuit OFS will be described in detail later.

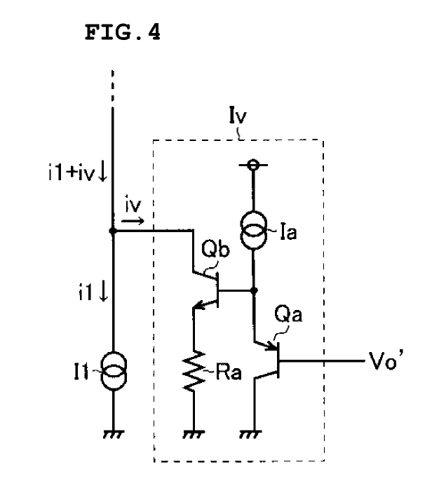

FIG. 4 is a circuit diagram showing one example of construction of the variable current source Iv.

As is shown in this figure, the variable current source Iv of the present embodiment comprises a PNP bipolar transistor Qa, an NPN bipolar transistor Qb, a resistor Ra, and a constant current source Ia.

The base of the transistor Qa corresponds to the feedback voltage application terminal of the variable current source Iv. The emitter of the transistor Qa is connected to the power supply application terminal via the constant current source Ia, and is also connected to the base of the transistor Qb. The collector of the transistor Qa is grounded. The emitter of the transistor Qb is grounded via the resistor Ra. The collector of the transistor Qb corresponds to the output terminal of the variable current source Iv.

First, the basic operation of the power supply device 20 constructed as described above (the voltage drop operation of the series regulator system) will be described.

The error amplifier ERR amplifies the differential voltage between the target voltage Vtg (starting voltage of the direct-current voltage source E1) applied to the inverting input terminal (−) and the feedback voltage Vo′ applied to the non-inverting input terminal (+), so that an error voltage Verr is produced. Specifically, in cases where the feedback voltage Vo′ does not reach the target voltage Vtg, the error amplifier ERR sets the voltage level of the error voltage Verr at a low level; then, after the feedback voltage Vo′ reaches the target voltage Vtg, the error amplifier ERR increases the voltage level of the error voltage Verr as the error between the feedback voltage Vo′ and target voltage Vtg increases, i.e., as the output voltage Vo becomes higher than the target value Vreg.

Meanwhile, the above-mentioned error voltage Verr is applied to the gates of the transistors P1 and P2, and opening-and-closing control of the respective transistors is performed in accordance with the voltage level.

Accordingly, in the power supply device 20, opening-and-closing control of the transistors P1 and P2 is performed so that the feedback voltage Vo′ coincides with the target voltage Vtg, i.e., so that the output voltage Vo coincides with the target value Vreg.

Thus, in the power supply device 20 of the present preferred embodiment, the error amplifier ERR and direct-current voltage source E1 function as a control voltage producing unit that is arranged to produce a control voltage for the transistors P1 and P2 so that the output voltage Vo is a specified target value Vreg.

Next, the overcurrent protective action of the power supply device 20 will be described.

As is shown in the preceding FIG. 2 as well, the power supply device 20 of the present preferred embodiment, in addition to having a transistor P1 to produce the output voltage Vo, also preferably includes a transistor P2 which provides a portion of the output current io in order to detect the output current io, and a resistor R2 which produces a detection voltage Vim in accordance with the detection current io2 provided by the transistor P2.

In addition, the gate area of the transistor P1 is set at m times (e.g., 10,000 times) the gate area of the transistor P2. Accordingly, when an output current io1 flows through the transistor P1, a detection current io2 which is 1/10,000 of this output current io1 flows through the transistor P2.

Thus, in the power supply device 20 of the present preferred embodiment, since no output current detection resistor R2 is inserted in series with the transistor P1, the output current io can be detected without increasing the “on” resistance of the device.

Furthermore, in the power supply device 20 of the present preferred embodiment, the gates and drains of the transistors P1 and P2 are respectively connected in common, and a current detection resistor R2 is inserted on the source side of the transistor P2. As a result of the use of such a construction, the detection current io2 that is led into the transistor P2 from the input terminal T1 is circulated to the output terminal T2 together with the output current io1 that flows to the transistor P1. Accordingly, in the power supply device 20 of the present preferred embodiment, unnecessary current loss can be eliminated when the output current io is detected.

The combined current (i1+iv) of the constant current i1 and variable current iv flows through the resistor R1, and a reference voltage Vref is produced in accordance with this. Therefore, the voltage value of the reference voltage Vref drops in accordance with the rise of the combined current (i1+iv) that flows through the resistor R1. Conversely, the voltage value rises in accordance with the decrease in the combined current (i1+iv).

Meanwhile, the combined current (i2+io2) of the constant current i2 and detection current io2 flows through the resistor R2, and a detection voltage Vim is produced in accordance with this. Consequently, the voltage value of the detection voltage Vim drops in accordance with a rise in the combined current (i2+io2) that flows through the resistor R2; conversely, the voltage value rises in accordance with a drop in the combined current (i2+io2).

Furthermore, the transistors Q1 and Q2 whose respective diodes are connected to the resistors R1 and R2 adjust the voltage levels of the reference voltage Vref and detection voltage Vim, and secure the operating voltage of the offset circuit OFS. As is shown in this figure, one stage each may be inserted, or two stages each may be inserted.

As is shown in the preceding FIG. 4 as well, the variable current source Iv is a voltage/current conversion circuit which applies a current capacity by the constant current source Ia while raising the voltage level of the feedback voltage Vo′ by 1 Vf using the transistor Qa and then lowering this level by 1 Vf using the transistor Qb, and which applies a voltage that has the same value as the feedback voltage Vo′ to one end of the resistor Ra, so that the desired variable current iv (=Vo′/Ra) is produced. In other words, the variable current source Iv has a construction that lowers the variable current iv in accordance with the drop in the feedback voltage Vo′ (and therefore the output voltage Vo).

Furthermore, the variable current source Iv of the present preferred embodiment has a construction that produces a variable current iv utilizing the feedback voltage Vo′ that is fed back to the error amplifier ERR. However, the construction of the present invention is not limited to this. It is also possible to use a separate feedback voltage in accordance with the output voltage Vo.

As was also shown in FIG. 3, the offset circuit OFS preferably includes a differential amplifier (transistors QA through QD and constant current source IA) to which the reference voltage Vref and detection voltage Vim are applied, and this circuit has a construction in which the driving control of the transistor QF is performed in accordance with the differentially amplified output.

Specifically, the offset circuit OFS preferably has the following construction. When the detection voltage Vim is higher than the reference voltage Vref, the offset circuit OFS places the transistor QF in a cut-off state, so that there is no application of an offset to the error voltage Verr; conversely, when the detection voltage Vim is lower than the reference voltage Vref, an offset in the positive direction is applied to the error voltage Verr so that the conductivity of the transistor QF (and therefore the voltage level of the error voltage Verr) is gradually increased, i.e., so that the transistors P1 and P2 are gradually closed, in accordance with the increase in the differential voltage.

As was described above, the power supply device 20 of the present preferred embodiment preferably has a construction including a transistor P1 connected in series between an input terminal T1 to which an input voltage Vi is applied and an output terminal T2 from which an output voltage Vo is led out; a transistor P2 which is connected between the input terminal T1 and output terminal T2 in parallel with the transistor P1, and which is used to lead out a portion of the output current io to the load (not shown) as a detection current io2; a control voltage producing unit (for example, including the error amplifier ERR and direct-current voltage source E1) which produces the gate voltages (error voltage Verr) of the transistors P1 and P2 so that the output voltage Vo is a specified target value Vreg; a constant current source I1 which produces a constant current i1; a variable current source Iv which produces a variable current iv in accordance with the output voltage Vo; a resistor R1 which produces a reference voltage Vref in accordance with the combined current (i1+iv) of the constant current i1 and variable current iv; a constant current source 12 which produces a constant current i2; a resistor R2 which produces a detection voltage Vim in accordance with the combined current (i2+io2) of the constant current i2 and detection current io2; and an offset circuit OFS which applies an offset to the error voltage Verr in accordance with the reference voltage Vref and detection voltage Vim.

To describe this more specifically, in the power supply device 20 of the present preferred embodiment, the variable current source Iv reduces the variable current iv in accordance with a drop in the output voltage Vo. The voltage values of the reference voltage Vref and detection voltage Vim rise in accordance with a drop in the currents respectively flowing through the resistors R1 and R2. When the detection voltage Vim is higher than the reference voltage Vref, the offset circuit OFS applies no offset to the error voltage Verr; conversely, when the detection voltage Vim is lower than the reference voltage Vref, an offset is applied to the error voltage Verr so that the transistors P1 and P2 are closed in accordance with the increase in the differential voltage.

In the power supply device 20 of the present preferred embodiment, as a result of the use of such a construction, when the output current io reaches the maximum upper limit value Ilmt, and the output voltage Vo begins to be lowered, the variable current iv also begins to be lowered along with this voltage, so that the reference voltage Vref is increased, and the upper limit value of the output current io is therefore more constricted. Furthermore, as is also shown in the preceding FIG. 4, since the variable current source Iv uses a construction in which the variable current iv is set at zero when the output voltage Vo becomes zero, the output current io ultimately settles down to a short current ishort which is determined only by the constant current i1.

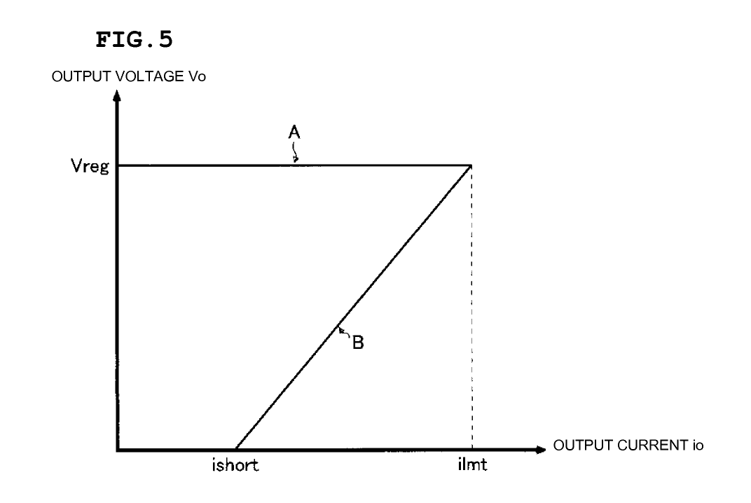

Accordingly, in the power supply device 20 of the present preferred embodiment, overcurrent protection is performed so that the correlation characteristics of the output current io and output voltage Vo show the “fold-back drooping characteristics” of FIG. 5.

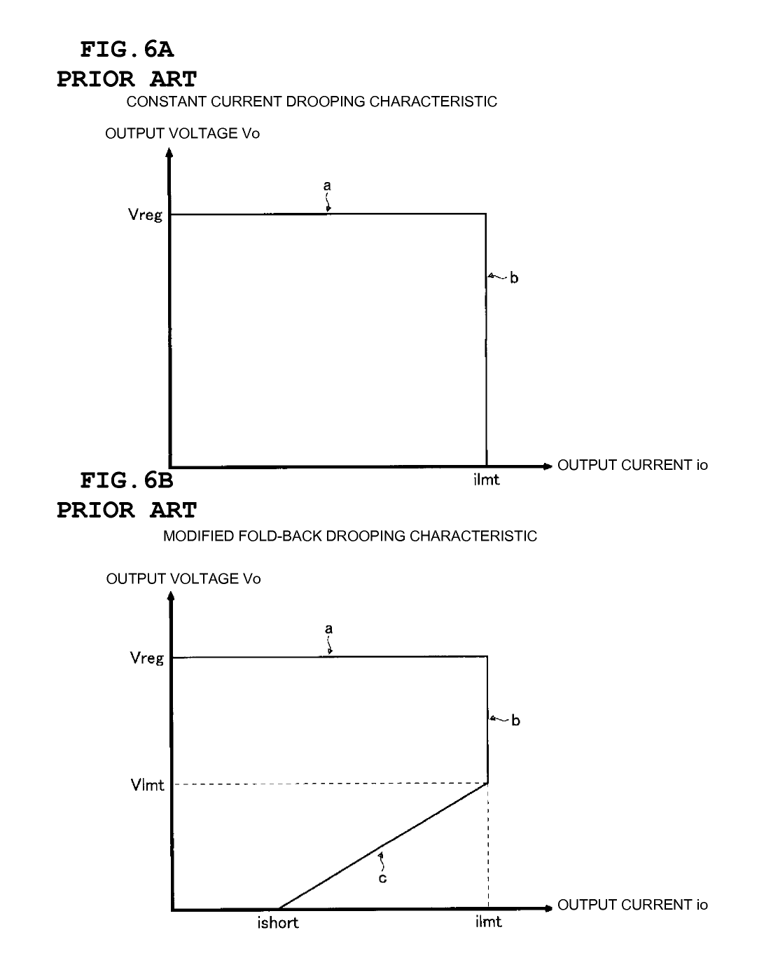

Specifically, as is shown in FIG. 5, the overcurrent protective behavior in the present preferred embodiment includes only a first protective period A (horizontal period) in which the output voltage Vo is maintained at the target value Vreg without any limitation of the output current io, and a second protective period B (fold-back period) in which the output current io and output voltage Vo are both reduced in a recursive configuration after the output current io reaches the maximum upper limit value ilmt. In other words, the overcurrent protective behavior in the present preferred embodiment differs from conventional behavior in that the output current io is clamped to a specified upper limit value ilmt, so that the behavior includes no protective period (vertical period) in which the output voltage Vo is reduced in a drooping configuration (compare FIGS. 5 and 6).

Thus, in the power supply device 20 of the present preferred embodiment, since the decrease in the output voltage Vo and output current io is initiated without any lag after the output current io reaches the maximum upper limit value Ilmt, a stable overcurrent protective action can be realized while suppressing unnecessary power loss. Accordingly, the stability and reliability of the device with respect to output short-circuiting and the like is reliably and significantly increased.

Furthermore, as was described above, the power supply device 20 of the present preferred embodiment preferably has a construction including a constant current source I1 used to set the final short current Ishort of the overcurrent protection and a variable current source Iv used to variably set the upper limit value of the output current io in accordance with the output voltage Vo to produce a reference voltage Vref for determining the upper limit value of the output current io.

Therefore, in the power supply device 20 of the present preferred embodiment, the overcurrent protection point (short point and limit point) can be arbitrarily set by adjusting the ratio of the constant current i1 and variable current iv. Consequently, when the power supply device 20 is started, the danger of problems such as a complete failure of the device to rise because of an unintentional limitation of the output current can be minimized.

Furthermore, in the power supply device 20 of the present preferred embodiment, field effect transistors are preferably used as the transistors P1 and P2. If such a construction is used, the bypass current required when bipolar transistors are used becomes unnecessary. As a result, even in cases where the output current io to the load increases, the current consumed by the power supply device 20 itself can be suppressed to a low value.

Furthermore, in the above-mentioned preferred embodiments, a case in which the present invention was applied to the power supply device of an electrical device using a battery was described as an example. However, the construction of the present invention is not limited to this and the present invention can be widely applied to power supply devices mounted in other electrical devices.

Furthermore, besides the preferred embodiments described above, the construction of the present invention can be variously modified without departing from the spirit of the invention.

Preferred embodiments of the present invention provide a useful technique which can achieve both a reduction in power consumption and overcurrent protection in direct-current stabilized power supply devices that produce a desired output voltage from an input voltage.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A power supply device comprising:
a first transistor connected in series between an input terminal to which an input voltage is applied and an output terminal from which an output voltage is led out;
a second transistor connected between said input terminal and said output terminal in parallel with the first transistor, and which is arranged to supply a portion of the output current to a load as a detection current;
a control voltage production unit arranged to produce a control voltage of the first and second transistors so that said output voltage is maintained at a specified target value;
a first constant current source arranged to produce a first constant current;
a variable current source arranged to produce a variable current in accordance with said output voltage;
a first resistor arranged to produce a reference voltage in accordance with a combined current of the first constant current and said variable current;
a second constant current source arranged to produce a second constant current;
a second resistor arranged to produce a detection voltage in accordance with a combined current of the second constant current and said detection current; and
an offset circuit arranged to apply an offset to said control voltage in accordance with said reference voltage and said detection voltage.

2. The power supply device according to claim 1, wherein said variable current source is arranged to reduce said variable current in accordance with a drop in said output voltage, said reference voltage and said detection voltage exhibit an increase in voltage value in accordance with a decrease in currents respectively flowing through the first and second resistors, and said offset circuit does not apply any offset to said control voltage when said detection voltage is higher than said reference voltage, and conversely said offset circuit applies an offset to said control voltage so that the first and second transistors are closed in accordance with the increase in the differential voltage when said detection voltage is lower than said reference voltage.

3. The power supply device according to claim 1, wherein said variable current source comprises:
a constant current source arranged to produce a specified constant current;
a PNP bipolar transistor whose emitter is connected to the output terminal of said constant current source, whose collector is connected to the ground terminal, and whose base is connected to the application terminal of said output voltage or a divided voltage thereof; and
an NPN bipolar transistor whose base is connected to the emitter of said PNP bipolar transistor, whose emitter is connected to the ground terminal via a resistor, and whose collector is connected to the output terminal of said variable current.

4. The power supply device according to claim 1, wherein the first and second transistors are field effect transistors.

5. The power supply device according to claim 1, wherein said first and second transistors are P-channel field effect transistors.

6. The power supply device according to claim 1, wherein the offset circuit includes NPN bipolar transistors, PNP bipolar transistors, a resistor, and a constant current source.

7. The power supply device according to claim 1, wherein the variable current source includes a PNP bipolar transistor, an NPN bipolar transistor, a resistor, and a constant current source.

8. The power supply device according to claim 1, wherein the offset circuit includes a differential amplifier to which said reference voltage and said detection voltage and such that driving control of one of said first and second transistors is performed in accordance with differentially amplified output produced by the offset circuit.

9. An electrical device comprising a power supply device according to claim 1.
